(19) United States
(12) Patent Application Publication
(10) Pub. No.: US 2012/0281202 A1
(43) Pub. Date: Nov. 8, 2012

(54) PRINTING APPARATUS AND PAPER SIZE IDENTIFYING METHOD FOR THE APPARATUS

(75) Inventors: WEN-CHUNG LO, Tu-Cheng (TW); YI-LONG LEE, Tu-Cheng (TW); SHU-YA CHIANG, Tu-Cheng (TW)

(73) Assignee: HON HAI PRECISION INDUSTRY CO., LTD., Tu-Cheng (TW)

(21) Appl. No.: 13/215,241

(22) Filed: Aug. 23, 2011

(30) Foreign Application Priority Data
May 5, 2011 (TW) 100115680

(51) Int. Cl. G01N 21/35; G01B 11/00

(52) U.S. Cl. 356/51; 356/625

(57) ABSTRACT

A printing apparatus capable of detecting a number of different paper sizes includes a main body, an input device, a paper guide, a rack member, and a detector. The main body prints on paper; the input device contains the paper; the paper guide moves to fit two sides of the paper; the rack member moves simultaneously with the paper guide, and includes at least one identifier; each identifier corresponding to one of the different paper sizes. The detector detects the identifier to determine one of the different paper sizes and transmits the determined paper size to the main body, and the main body compares the determined paper size with a print setup. The main body reminds a user when the determined paper size does not conform to the print setup.

### BACKGROUND

1. Technical Field

The present disclosure relates to printing apparatuses and, particularly, to a printing apparatus using a paper size identifying method

2. Description of Related Art

Printing apparatuses generally print out words or images on paper in accordance with the input data. A paper tray is often used to contain the paper and feed the paper to a printing apparatus along a paper guide, and the paper guide can be adjusted to fit different paper sizes. However, a printing apparatus itself is unable to detect the paper size, and may waste printing consumables when the paper size does not conform to the printing setup, such as printing a small image on an excessively large piece of paper, or vice versa.

Therefore, what is needed is a paper size identifying method for a printing apparatus.

### BRIEF DESCRIPTION OF THE DRAWINGS

The components in the drawings are not necessarily drawn to scale, the emphasis instead being placed upon clearly illustrating the principles of a paper size identifying method for a printing apparatus. Moreover, in the drawings, like reference numerals designate corresponding parts throughout the several views.

FIG. 1 is a schematic diagram of a printing apparatus in accordance with an exemplary embodiment.

FIGS. 2A-2C are schematic diagrams for a paper size identifying method, in accordance with an exemplary embodiment.

FIG. 3 is a flowchart of a method for identifying a paper size, in accordance with an exemplary embodiment.

### DETAILED DESCRIPTION

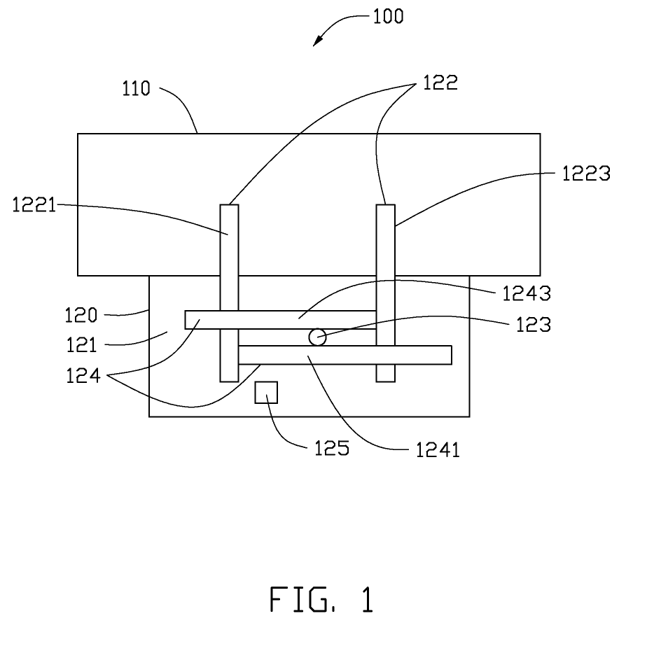

Referring to FIG. 1, a printing apparatus 100 includes a main body 110 and an input device 120. The input device 120 contains paper (not shown) and feeds the paper to the main body 110; the main body 110 prints on the paper. In the present embodiment, the paper can be plain paper, photo paper, thermal paper or other printing material; the main body 110 prints on the paper with ink, toner, or other printing methods.

The input device 120 includes a paper tray 121, a paper guide 122, a rack member 124, a gear wheel 123, and a detector 125. The paper tray 121 is engageably attached to the main body 110 to feed the paper.

The paper guide 122, including a first adjustor 1221 and a second adjustor 1223 arranged in parallel, can be adjusted to fit the paper on the paper tray 121. The first adjustor 1221 and the second adjustor 1223 moves horizontally on the paper tray 121 to fit both sides of the paper, the paper guide 122 drives a rack member 124 to move. The rack member 124 includes a first rack 1243 and a second rack 1241 respectively connecting perpendicular to the first adjustor 1221 and the second adjustor 1223. The first rack 1243 and the second rack 1241 move simultaneously with the first adjustor 1221 and the second adjustor 1223. The first rack 1243 and the second rack 1241 are arranged in parallel and toothed, the teeth (not shown) on the first rack 1243 and the second rack 1241 mesh with the gear wheel 123 to ensure the first rack 1243 and the second rack 1241 are moving the same distance in opposite directions. As well as ensuring the first adjustor 1221 and the second adjustor 1223 are in unison when being adjusted.

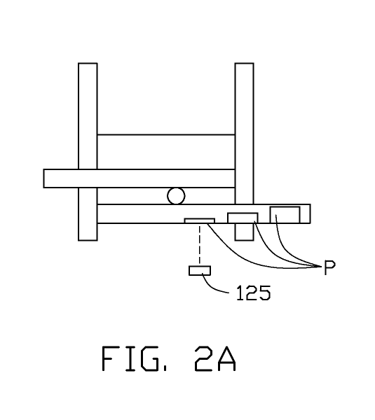

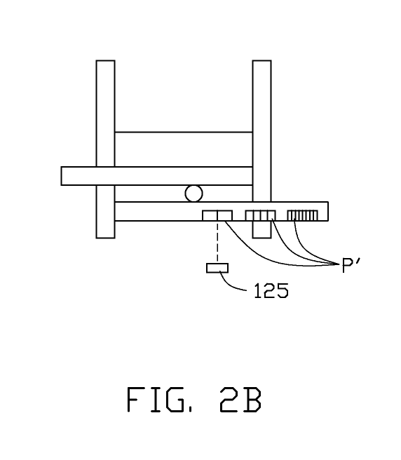

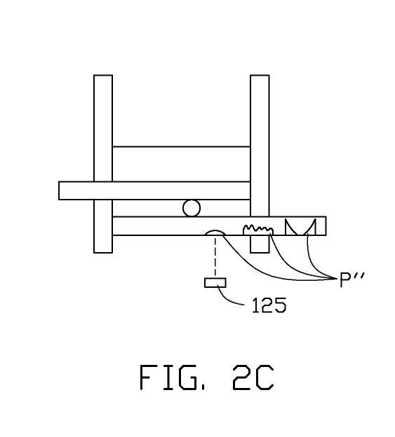

Referring to FIGS. 2A-2C, three depth identifiers P (FIG. 2A) are arranged on the second rack 1241 from left to right, corresponding to paper sizes A3, A4, A5. In the present embodiment, the depth identifiers P are rectangular pits with different depth. The detector 125, electrically connecting with the main body 110, is arranged on the input device 120 to detect the three identifiers P arranged on the second rack 1241. When the paper guide 122 moves to fit the both sides of the paper, the second rack 1241 moves simultaneously with the second adjustor 1221, and the detector 125 aligns with one of the identifiers P to determine the paper size. In other embodiments, roughness identifiers P′ (FIG. 2B) and shape identifiers P″ (FIG. 2C) can be used.

By way of example, in FIG. 2A, the three depth identifier P are rectangular pits with 0.5 cm, 0.8 cm, and 1.0 cm depth, from left to right. When A5 paper is placed onto the paper tray 121, the first adjustor 1221 and the second adjustor 1223 are adjusted by the main body 110 or by manual operation to fit the both sides of the A5 paper. The second rack 1241 is driven by the second adjustor 1223, and thus aligns the 1.0 cm rectangular pit to the detector 125. The main body 110 identifies the paper size as A5 when detector 125 detects the 1.0 cm rectangular pit. In FIG. 2B, the three roughness identifier P′ are rectangular pits with low roughness, medium roughness, and high roughness, from left to right. When A5 paper is placed onto the paper tray 121, the main body 110 identifies the paper size as A5 when detector 125 detects the high roughness rectangular pit. In FIG. 2C, the three shape identifier P″ are rectangular pits with concave bottom, rugged bottom, and convex bottom, from left to right. When A5 paper is placed onto the paper tray 121, the main body 110 identifies the paper size as A5 when detector 125 detects the convex rectangular pit. In the present embodiment, the detector 125 is an infrared detector.

The main body 110 compares the paper size detected with the printer setup set by the user to determine whether they are conformed. The main body 110 reminds the user if the paper size does not conform to the print setup.

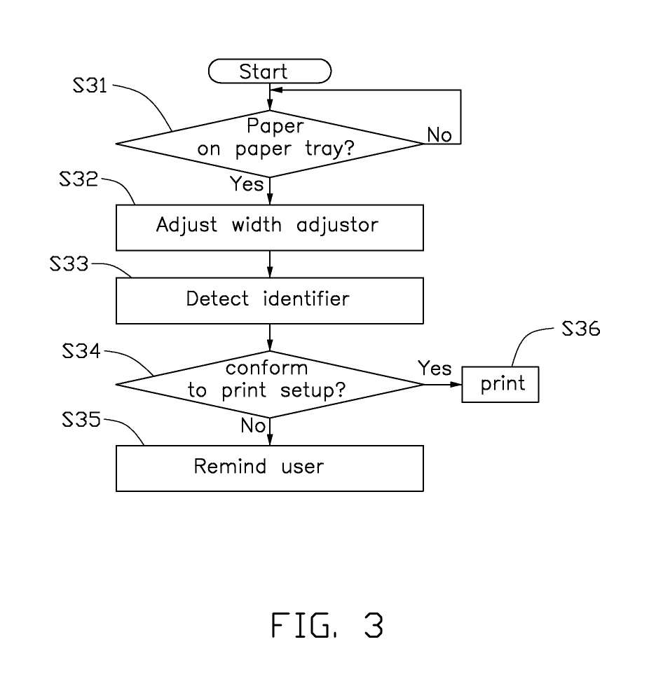

Referring to FIG. 3, a flowchart for identifying the paper size is illustrated. In step 31, the main body 110 determines whether the paper is on the paper tray 121.

In step 32, if the paper is on the paper tray 121, the paper guide 122 is adjusted to fit the both sides of the paper, and drives the rack member 124.

In step 33, one of the identifiers on the second rack is detected by the detector 125 to identify the paper size, and the detector 125 transmits the paper size to the main body 110.

In step 34, the main body 110 determines whether the paper size conforms to the print setup.

In step 35, the main body 110 reminds the user if the paper size does not conform to the print setup.

In step 36, the main body 110 proceeds to print on the paper if the paper size conforms to the print setup.

Therefore, the printing device 100 can save printing consumables by detecting different paper sizes and comparing the paper size with the print setup to remind the user when the paper size does not conform to the print setup.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A printing apparatus capable of detecting a plurality of different paper sizes, comprising:
a main body to print on paper;
an input device to contain the paper;
a paper guide capable of moving to fit two sides of the paper;
a rack member to move simultaneously with the paper guide; the rack member comprising at least one identifier, and each identifier corresponding to one of the plurality of different paper sizes; and
a detector to detect one of the at least one identifier to determine one of the different paper sizes and transmit the determined paper size to the main body.

2. The printing apparatus as claimed in claim 1, wherein the main body is capable of comparing the determined paper size with a print setup; the main body reminds a user when the determined paper size does not conform to the print setup.

3. The printing apparatus as claimed in claim 1, wherein the at least one identifier comprises a plurality of identifiers, the identifiers are pits with different depths, different roughness, or different shapes.

4. The printing apparatus as claimed in claim 1, wherein the detector is an infrared detector.

5. The printing apparatus as claimed in claim 1, wherein the rack member comprises a first rack and a second rack; the first rack and the second rack are toothed and arranged in parallel; a gear wheel is meshed between the first rack and the second rack.

6. The printing apparatus as claimed in claim 5, wherein the at least one identifier is arranged on the second rack.

7. A paper size identifying method for a printing apparatus, comprising:
determining whether paper is in an input device;
adjusting a paper guide to fit two sides of the paper;
detecting at least one identifier moving simultaneously with the paper guide; and
determining a determined paper size associated with the one of the at least one identifier.

8. The method as claimed in claim 7, further comprising:
determining whether the determined paper size conforms to a print setup;
reminding a user if the determined paper size does not conforms to the print setup; and
printing on the paper if the determined paper size conforms to the print setup.

9. The method as claimed in claim 7, wherein the at least one identifier is arranged on a rack member moving simultaneously with the paper guide; the rack member comprises a first rack and a second rack; the first rack and the second rack are toothed and arranged in parallel; a gear wheel is meshed between the first rack and the second rack.

10. The method as claimed in claim 7, wherein the at least one identifier comprises a plurality of identifiers, the identifiers are pits with different depths, different roughness, or different shapes.

11. The method as claimed in claim 7, wherein the printing apparatus comprises a detector to detect the at least one identifier.

12. The method as claimed in claim 11, wherein the detector is an infrared detector.
